(19) United States
(12) Patent Application Publication
(10) Pub. No.: US 2010/0177726 A1
(43) Pub. Date: Jul. 15, 2010

(54) METHOD AND SYSTEM FOR SYNCHRONIZATION AND CELL IDENTIFICATION WITHIN COMMUNICATION SYSTEMS

(76) Inventor: Kim OLSZEWSKI, South Jordan, UT (US)

Correspondence Address: MORRISON & FOERSTER LLP, 12531 HIGH BLUFF DRIVE, SUITE 100, SAN DIEGO, CA, 92130-2040, US

(21) Appl. No.: 12/686,263

(22) Filed: Jan. 12, 2010

Related U.S. Application Data
(60) Provisional application No. 61/144,074, filed on Jan. 12, 2009.

(51) Int. Cl. H04W 72/04

(52) U.S. Cl. 370/329

(57) ABSTRACT

A system is disclosed for synchronization and cell identification within a communication system. The system includes a station, within the communication system, having a processing unit configured to obtain a primary synchronization channel including one or more symbols from a primary synchronization lookup table in a storage unit, and a secondary synchronization channel including one or more symbols from a secondary synchronization lookup table in the storage unit. The station further includes a transceiver unit configured to transmit to another station a reference signal via a synchronization channel, including the primary synchronization channel and the secondary synchronization channel. According to various embodiments, the primary synchronization channel includes one or more symbols encoded with synchronization data, and the secondary synchronization channel includes one or more symbols encoded with cell identification data.

### CROSS-REFERENCE TO RELATED APPLICATIONS

This application claims priority to U.S. Provisional Patent Application No. 61/144,074 filed on Jan. 12, 2009, entitled “Synchronization and Cell Identification within OFDM-Based Communication Systems”, the contents of which are incorporated by reference herein in their entirety.

### FIELD OF THE INVENTION

The present invention relates generally to wireless communication systems, and more particularly to synchronization and cell identification within communication systems.

### BACKGROUND

With the increasing popularity of mobile devices, there exists a need to allow a mobile station to communicate with various base or relay stations within a communication system, depending on their current location.

Synchronization and cell identification are key requirements that a station needs to address within an 802.16 system implementation, for example, when a mobile station moves between various cell and/or cell clusters.

Therefore, there is a need in the art for efficient methods and systems for synchronization and cell identification within a communication system, which can support various bandwidths and multi-carrier implementations, and can minimize the number of detection hypothesis tests for cell/sector identification.

### SUMMARY

The presently disclosed embodiments are directed to solving one or more of the problems presented in the prior art, described above, as well as providing additional features that will become readily apparent by reference to the following detailed description when taken in conjunction with the accompanying drawings.

In the following description, embodiments of the disclosure are disclosed that support numerous channel bandwidths defined in the 802.16 Requirements Document and the numerous radio environments and associated channel conditions defined in the 802.16 Evaluation Methodology Document, to illustrate various principles of the disclosure. However, the proposed methods and systems can be utilized for any Orthogonal Frequency Division Multiplexing/Multiple Access (OFDM/OFDMA)-based system including Long Term Evolution (LTE) and Ultra Mobile Broadband (UMB).

One embodiment is directed to a method for synchronization and cell identification within a communication system. The method may include obtaining a primary synchronization channel including one or more symbols from a primary synchronization lookup table; obtaining a secondary synchronization channel including one or more symbols from a secondary synchronization lookup table; and transmitting a reference signal via a synchronization channel, including the primary synchronization channel and the secondary synchronization channel. According to certain embodiments, the primary synchronization channel includes one or more symbols encoded with synchronization data, and the secondary synchronization channel includes one or more symbols encoded with cell identification data.

Another embodiment is directed to a system for synchronization and cell identification within a communication system. The system includes a station, within the communication system, having a processing unit configured to obtain a primary synchronization channel including one or more symbols from a primary synchronization lookup table in a storage unit, and a secondary synchronization channel including one or more symbols from a secondary synchronization lookup table in the storage unit. The station further includes a transceiver unit configured to transmit to another station a reference signal via a synchronization channel, including the primary synchronization channel and the secondary synchronization channel. According to various embodiments, the primary synchronization channel includes one or more symbols encoded with synchronization data, and the secondary synchronization channel includes one or more symbols encoded with cell identification data.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following Figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is an illustration of an exemplary OFDM/OFDMA mobile radio channel operating environment, according to one embodiment of the present invention.

FIG. 2 is an illustration of an exemplary OFDM/OFDMA exemplary communication system according to one embodiment of the present invention.

FIG. 3 is an exemplary table of cell identifiers, according to one embodiment of the present invention.

FIG. 4 is an exemplary table of P-SCH modes associated with a cell or relay station, according to one embodiment of the present invention.

FIG. 5 is an exemplary table showing a map for encoding P-SCH modes, at various cell cluster indices and cell sector indices, according to one embodiment of the present invention.

FIG. 6 is an exemplary table showing how samples of a P-SCH sequence are mapped to the subcarriers of a downlink OFDMA symbol, according to one embodiment of the present invention.

FIG. 7 shows an exemplary map for encoding cell indices using sequences in the S-SCH codebook, according to one embodiment of the present invention.

FIG. 8 shows an exemplary table indicating the mapping of samples of the S-SCH sector sequences to the subcarriers of a downlink OFDMA symbol, according to one embodiment of the present invention.

FIG. 9 shows an exemplary table indicating received signal-to-interference ratios based on cluster sizes, according to one embodiment of the present invention.

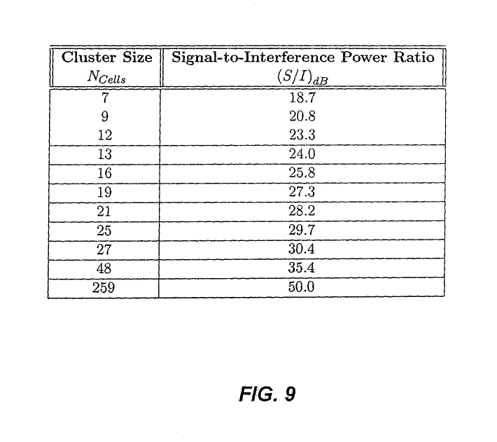

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Embodiments disclosed herein describe a wireless cellular communication system where the transmission direction from a base station to mobile station is called downlink, while the opposite direction is called uplink. On both downlink and uplink, the radio signal transmissions over the time are divided into periodic frames (or subframes, slots, etc). Each radio frame contains multiple time symbols that include data symbols (DS) and reference symbols (RS). Data symbols carry the data information, while the reference symbols are known at both transmitter and receiver, and are used for channel estimation purposes. Note that the functions described in the present disclosure may be performed by either a base station or a mobile station. A mobile station may be any user device such as a mobile phone, and a mobile station may also be referred to as user equipment (UE).

Aspects of the present disclosure are directed toward systems and methods for OFDM/OFDMA frame structure technology for communication systems. Embodiments of the invention are described herein in the context of one practical application, namely, communication between one or more base stations and a plurality of mobile devices. In this context, the exemplary system is applicable to provide data communications between a base station and a plurality of mobile devices. Embodiments of the disclosure, however, are not limited to such base station and mobile device communication applications, and the methods described herein may also be utilized in other applications such as mobile-to-mobile communications, or wireless local loop communications. As would be apparent to one of ordinary skill in the art after reading this description, these are merely examples and the invention is not limited to operating in accordance with these examples. Assignment of resources within a frame to the data being carried can be applied to any digital communications system with data transmissions organized within a frame structure and where the full set of such resources within a frame can be flexibly divided according to portions of different sizes to the data being carried. Thus, the present disclosure is not limited to any particular type of communication system; however, embodiments of the present invention are described herein with respect to exemplary OFDM/OFDMA systems.

As explained in additional detail below, OFDM/OFDMA frame structure comprises a variable length sub-frame structure with an efficiently sized cyclic prefix operable to effectively utilize OFDM/OFDMA bandwidth. The frame structure provides compatibility with multiple wireless communication systems.

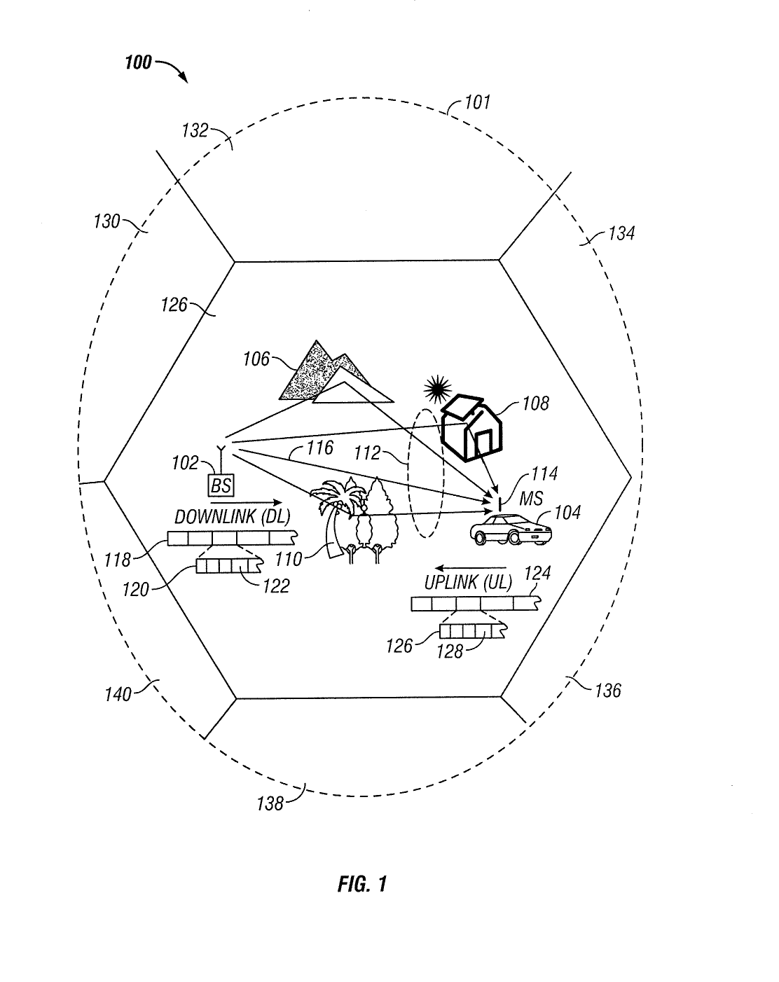

FIG. 1 illustrates a mobile radio channel operating environment 100, according to one embodiment of the present invention. The mobile radio channel operating environment 100 may include a base station (BS) 102, a mobile station (MS) 104, various obstacles 106/108/110, and a cluster of notional hexagonal cells 126/130/132/134/136/138/140 overlaying a geographical area 101. Each cell 126/130/132/134/136/138/140 may include a base station operating at its allocated bandwidth to provide adequate radio coverage to its intended users. For example, the base station 102 may operate at an allocated channel transmission bandwidth to provide adequate coverage to the mobile station 104. The exemplary mobile station 104 in FIG. 1 is an automobile; however mobile station 104 may be any user device such as a mobile phone. Alternately, mobile station 104 may be a personal digital assistant (PDA) such as a Blackberry device, MP3 player or other similar portable device. According to some embodiments, mobile station 104 may be a personal wireless computer such as a wireless notebook computer, a wireless palmtop computer, or other mobile computer devices.

The base station 102 and the mobile station 104 may communicate via a downlink radio frame 118, and an uplink radio frame 124 respectively. Each radio frame 118/124 may be further divided into sub-frames 120/126 which may include data symbols 122/124. In this mobile radio channel operating environment 100, a signal transmitted from a base station 102 may suffer from the operating conditions mentioned above. For example, multipath signal components 112 may occur as a consequence of reflections, scattering, and diffraction of the transmitted signal by natural and/or man-made objects 106/108/110. At the receiver antenna 114, a multitude of signals may arrive from many different directions with different delays, attenuations, and phases. Generally, the time difference between the arrival moment of the first received multipath component 116 (typically the line of sight component), and the last received multipath component (possibly any of the multipath signal components 112) is called delay spread. The combination of signals with various delays, attenuations, and phases may create distortions such as ISI and ICI in the received signal. The distortion may complicate reception and conversion of the received signal into useful information. For example, delay spread may cause ISI in the useful information (data symbols) contained in the radio frame 124.

OFDM can mitigate delay spread and many other difficult operating conditions. OFDM divides an allocated radio communication channel into a number of orthogonal subchannels of equal bandwidth. Each subchannel is modulated by a unique group of subcarrier signals, whose frequencies are equally and minimally spaced for optimal bandwidth efficiency. The group of subcarrier signals are chosen to be orthogonal, meaning the inner product of any two of the subcarriers equals zero. In this manner, the entire bandwidth allocated to the system is divided into orthogonal subcarriers. OFDMA is a multi-user version of OFDM. For a communication device such as the base station 102, multiple access is accomplished by assigning subsets of orthogonal sub-carriers to individual subscriber devices. A subscriber device may be a mobile station 104 with which the base station 102 is communicating.

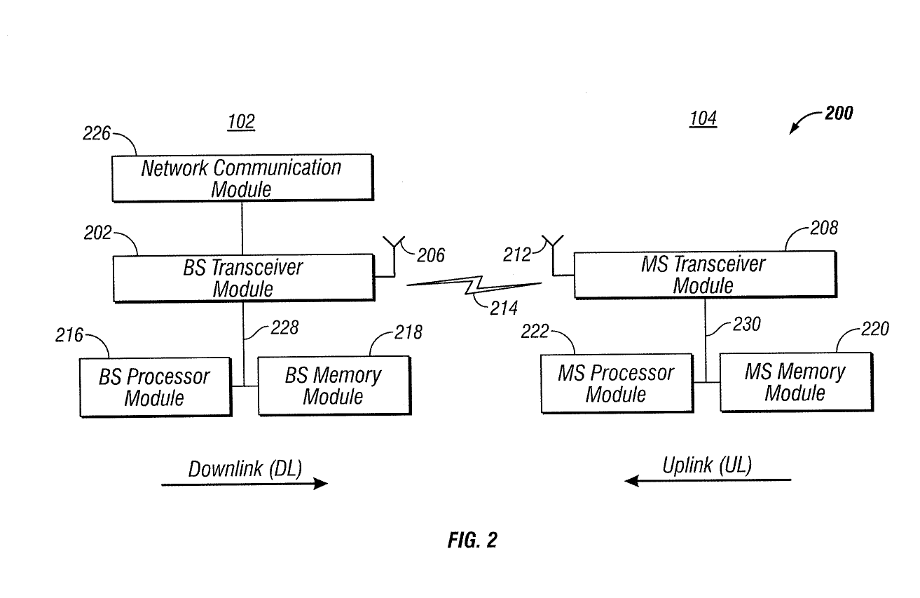

FIG. 2 shows an exemplary wireless communication system 200 for transmitting and receiving OFDM/OFDMA transmissions, in accordance with one embodiment of the present invention. The system 200 may include components and elements configured to support known or conventional operating features that need not be described in detail herein. In the exemplary embodiment, system 200 can be used to transmit and receive OFDM/OFDMA data symbols in a wireless communication environment such as the wireless communication environment 100 (FIG. 1). System 200 generally comprises a base station 102 with a base station transceiver module 202, a base station antenna 206, a base station processor module 216 and a base station memory module 218. As is described in greater detail herein, any number of base station antennas 206 may be included. System 200 generally comprises a mobile station 104 with a mobile station transceiver module 208, a mobile station antenna 212, a mobile station memory module 220, a mobile station processor module 222, and a network communication module 226. As is described in greater detail herein, any number of mobile station antennas 212 may be included. Of course both BS 102 and MS 104 may include additional or alternative modules without departing from the scope of the present invention.

Furthermore, these and other elements of system 200 may be interconnected together using a data communication bus (e.g., 228, 230), or any suitable interconnection arrangement. Such interconnection facilitates communication between the various elements of wireless system 200. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as causing a departure from the scope of the present invention.

In the exemplary OFDM/OFDMA system 200, the base station transceiver 202 and the mobile station transceiver 208 each comprise a transmitter module and a receiver module (not shown). Additionally, although not shown in this figure, those skilled in the art will recognize that a transmitter may transmit to more than one receiver, and that multiple transmitters may transmit to the same receiver. In a TDD system, transmit and receive timing gaps exist as guard bands to protect against transitions from transmit to receive and vice versa.

In the particular example of the OFDM/OFDMA system depicted in FIG. 2, an “uplink” transceiver 208 includes an OFDM/OFDMA transmitter that shares an antenna with an uplink receiver. A duplex switch may alternatively couple the uplink transmitter or receiver to the uplink antenna in time duplex fashion. Similarly, a “downlink” transceiver 202 includes an OFDM/OFDMA receiver which shares a downlink antenna with a downlink transmitter. A downlink duplex switch may alternatively couple the downlink transmitter or receiver to the downlink antenna in time duplex fashion.

Although many OFDM/OFDMA systems will use OFDM/OFDMA technology in both directions, those skilled in the art will recognize that the present embodiments of the invention are applicable to systems using OFDM/OFDMA technology in only one direction, with an alternative transmission technology (or even radio silence) in the opposite direction. Furthermore, it should be understood by a person of ordinary skill in the art that the OFDM/OFDMA transceiver modules 202/208 may utilize other communication techniques such as, without limitation, a frequency division duplex (FDD) communication technique.

The mobile station transceiver 208 and the base station transceiver 202 are configured to communicate via a wireless data communication link 214. The mobile station transceiver 208 and the base station transceiver 202 cooperate with a suitably configured RF antenna arrangement 206/212 that can support a particular wireless communication protocol and modulation scheme. In the exemplary embodiment, the mobile station transceiver 208 and the base station transceiver 202 are configured to support industry standards such as the Third Generation Partnership Project Long Term Evolution (3GPP LTE), Third Generation Partnership Project 2 Ultra Mobile Broadband (3 Gpp2 UMB), Time Division-Synchronous Code Division Multiple Access (TD-SCDMA), and Wireless Interoperability for Microwave Access (WiMAX), and the like. The mobile station transceiver 208 and the base station transceiver 202 may be configured to support alternate, or additional, wireless data communication protocols, including future variations of IEEE 802.16, such as 802.16e, 802.16m, and so on.

According to certain embodiments, the base station 102 controls the radio resource allocations and assignments, and the mobile station 104 is configured to decode and interpret the allocation protocol. For example, such embodiments may be employed in systems where multiple mobile stations 104 share the same radio channel which is controlled by one base station 102. However, in alternative embodiments, the mobile station 104 controls allocation of radio resources for a particular link, and could implement the role of radio resource controller or allocator, as described herein.

Processor modules 216/222 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. Processor modules 216/222 comprise processing logic that is configured to carry out the functions, techniques, and processing tasks associated with the operation of OFDM/OFDMA system 200. In particular, the processing logic is configured to support the OFDM/OFDMA frame structure parameters described herein. In practical embodiments the processing logic may be resident in the base station and/or may be part of a network architecture that communicates with the base station transceiver 202.

The steps of a method or algorithm described in connection with the embodiments disclosed herein may be embodied directly in hardware, in firmware, in a software module executed by processor modules 216/222, or in any practical combination thereof. A software module may reside in memory modules 218/220, which may be realized as RAM memory, flash memory, ROM memory, EPROM memory, EEPROM memory, registers, a hard disk, a removable disk, a CD-ROM, or any other form of storage medium known in the art. In this regard, memory modules 218/220 may be coupled to the processor modules 218/222 respectively such that the processors modules 216/220 can read information from, and write information to, memory modules 618/620. As an example, processor module 216, and memory modules 218, processor module 222, and memory module 220 may reside in their respective ASICs. The memory modules 218/220 may also be integrated into the processor modules 216/220. In an embodiment, the memory module 218/220 may include a cache memory for storing temporary variables or other intermediate information during execution of instructions to be executed by processor modules 216/222. Memory modules 218/220 may also include non-volatile memory for storing instructions to be executed by the processor modules 216/220.

Memory modules 218/220 may include a frame structure database (not shown) in accordance with an exemplary embodiment of the invention. Frame structure parameter databases may be configured to store, maintain, and provide data as needed to support the functionality of system 200 in the manner described below. Moreover, a frame structure database may be a local database coupled to the processors 216/222, or may be a remote database, for example, a central network database, and the like. A frame structure database may be configured to maintain, without limitation, frame structure parameters as explained below. In this manner, a frame structure database may include a lookup table for purposes of storing frame structure parameters.

The network communication module 226 generally represents the hardware, software, firmware, processing logic, and/or other components of system 200 that enable bi-directional communication between base station transceiver 202, and network components to which the base station transceiver 202 is connected. For example, network communication module 226 may be configured to support internet or WiMAX traffic. In a typical deployment, without limitation, network communication module 226 provides an 802.3 Ethernet interface such that base station transceiver 202 can communicate with a conventional Ethernet based computer network. In this manner, the network communication module 226 may include a physical interface for connection to the computer network (e.g., Mobile Switching Center (MSC)).

In accordance with embodiments described herein, time-frequency allocation units are referred to as Resource Blocks (RBs). A Resource Block (RB) is defined as a fixed-size rectangular area within a subframe comprised of a specified number of subcarriers (frequencies) and a specified number of OFDMA symbols (time slots). An RB is the smallest fundamental time-frequency unit that may be allocated to an 802.16m or LTE user.

A synchronization channel (SCH) is a downlink physical channel used as a reference signal for time/frequency synchronization, signal quality estimation, channel estimation, and location estimation for location-based services (LBS). The SCH may also be used for encoding cell/sector identifiers. The SCH may include, for example, a P-SCH (Primary-SCH) and an S-SCH (Secondary-SCH). P-SCH symbols can be used for time and frequency synchronization, P-SCH mode identification, cell cluster identification, and cell sector identification. S-SCH symbols may be used for cell identification. Both the P-SCH and/or S-SCH may be used for signal quality estimation, channel estimation, and location estimation.

Cells and sectors are logical network elements that are assigned unique physical layer SCH sequences. A group of multiple cells is defined as a cell cluster. A cluster is repeated throughout a network coverage area. Each cell within a cluster may be populated by a number of macrocell transmitters, a number of femtocell transmitters, and/or a number of relay station transmitters. Each macrocell, femtocell and relay station transmitter has its own unique identifier called a cell identifier. The set of cell identifiers is defined as:

I_{N}_{_{Ds}}={Cell_ID₀,Cell_ID₁, . . . , Cell ID_{N}_{_{IDs−1}}} (1)

The pth identifier is defined as:

Cell_IDₚ=f{i,j,k} (2)

Integers i, j and k are defined as follows:

Cell Cluster Index i ε{0,1, . . . , N_{Clusters}−1}

Cell Index j ε{0,1, . . . , N_{Cells}−1}

Cell Sector Index k ε{0,1, . . . , N_{Sectors}−1} (3)

Integers N_{Clusters}, N_{Cells} and N_{Sectors} denote the number of cell clusters, the number of cells per cluster, and the number of sectors per cell. These values are currently defined as N_{Clusters}=4, N_{Cells}=48, and N_{Sectors}=3. The values may be changed as the system expands. The number of cell identifiers currently supported is:

N_{IDs}·N_{Clusters}·N_{Cells}·N_{sectors}=576 (4)

The one-to-one function ƒ{i, j, k} defines a look-up table operation that maps indices i, j and k to a Cell_IDₚ in I_{N}_{_{IDs}}.

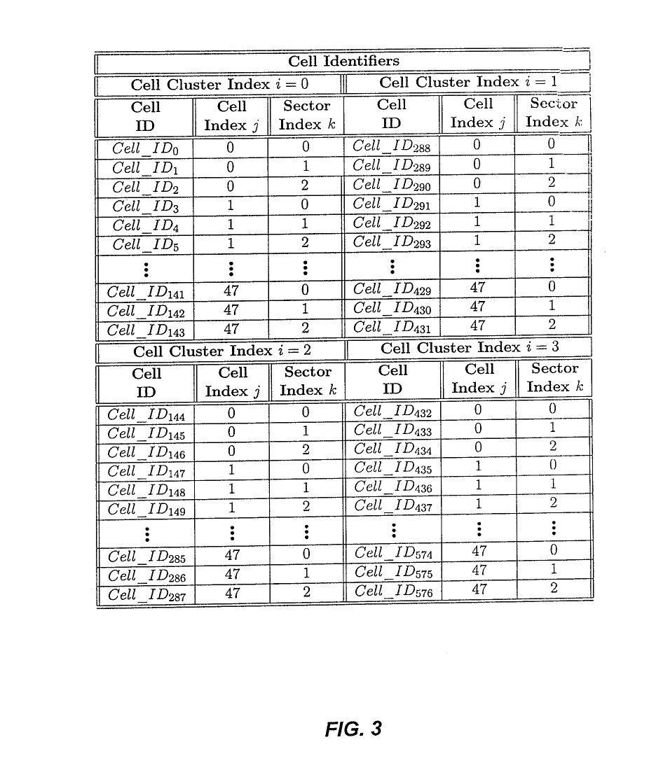

FIG. 3 defines the look-up table mapping for each Cell_IDp in I_{N}_{_{IDs}}. Indices i, j and k are encoded in transmitted P-SCH and S-SCH sequences. Transmitted P-SCH and S-SCH sequences are obtained from a P-SCH sequence codebook P and an S-SCH sequence codebook S. P-SCH sequences within P are orthogonal. Each sequence within P encodes a cell cluster index i and a cell sector index k. Frequency-domain detection of a sequence within P produces both a cluster index i and a sector index for a cell identifier Cell_IDp=f {i, j, k}. S-SCH sequences within S are orthogonal. Each sequence within S encodes a cell index j. Frequency-domain detection of an S-SCH sequence produces a cell index j for a cell identifier Cell_IDp=f {i, j, k}.

The P-SCH transmits a sequence from a P-SCH sequence codebook P. Each P-SCH sequence within P encodes a cell cluster index i, a cell sector index j and a P-SCH mode. Characteristics of the P-SCH are provided in FIG. 3. The exemplary table of cell identifiers of FIG. 3 assumes the following exemplary characteristics:
Fixed bandwidth of 5 MHz;
Frequency reuse of 1;
P-SCH codebook P common to all cell clusters;
Carries partial cell ID information (cell cluster and sector indices);
Supports system signaling using P-SCH modes; and
Supports signal quality estimation, channel estimation, and location estimation for location-based services (LBS).

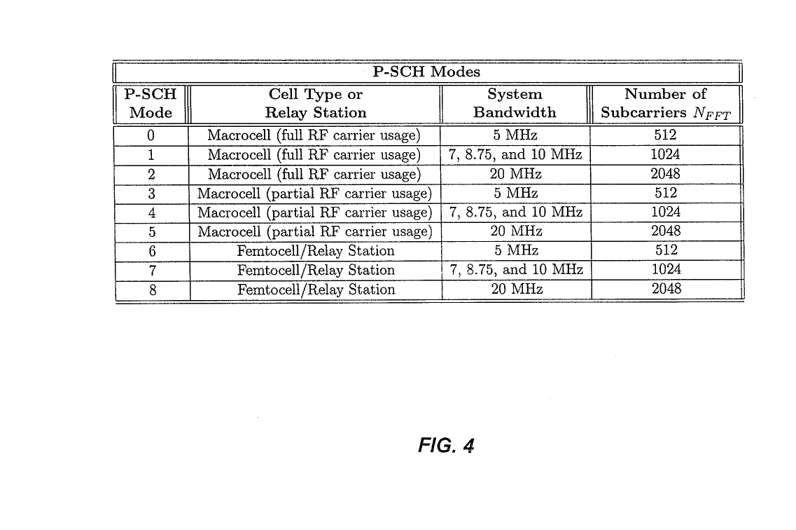

The P-SCH can be configured to operate in a number of P-SCH modes. P-SCH modes signal cell type, relay station, system bandwidths and RF carrier usage for multi-carrier support. P-SCH modes also facilitate the frequency-domain detection of subsequently transmitted S-SCH sequences, they specify the subcarriers used in S-SCH symbols. FIG. 4 defines an exemplary table of modes supported, according to one embodiment. If a vendor's system does not support all P-SCH modes a subset of the modes can be used. P-SCH modes are encoded using P-SCH sequences. Each mode is associated with a cell or relay station and its used bandwidth. The number of modes can be increased by simply adding another P-SCH sequence to encode the mode.

The P-SCH sequence codebook is defined as the orthogonal sequence set

P={P0,P1, . . . , P107} (5)

The ith P-SCH sequence in P is defined as

Pᵢ={Pᵢ[k]}ₖ₌₀^{L}^{_{P}}⁻¹=g_{P}[(k−i)mod L_{P}]ₖ₌₀^{L}^{_{P}}⁻¹,i=0,1, . . . , L_{P}−1 (6)

where

$${g}_{p} [ k ] = ej \frac{π}{{L}_{S}} k ( k - {L}_{P} ) \qquad ( 7 )$$

can be the P-SCH codebook generator sequence. If a vendor's system does not support all P-SCH modes a subset of the sequences can be used. The chosen sequences correspond with the modes supported. Sequences within P are of fixed length L_{P}=216. Each sequence within the codebook P encodes a unique P-SCH mode, cell cluster index i and a unique cell sector index k. Frequency-domain detection of a sequence Pᵢ produces a P-SCH mode and a cell cluster index i and a cell sector index k for a cell identifier Cell_IDp=f{i, j, k}.

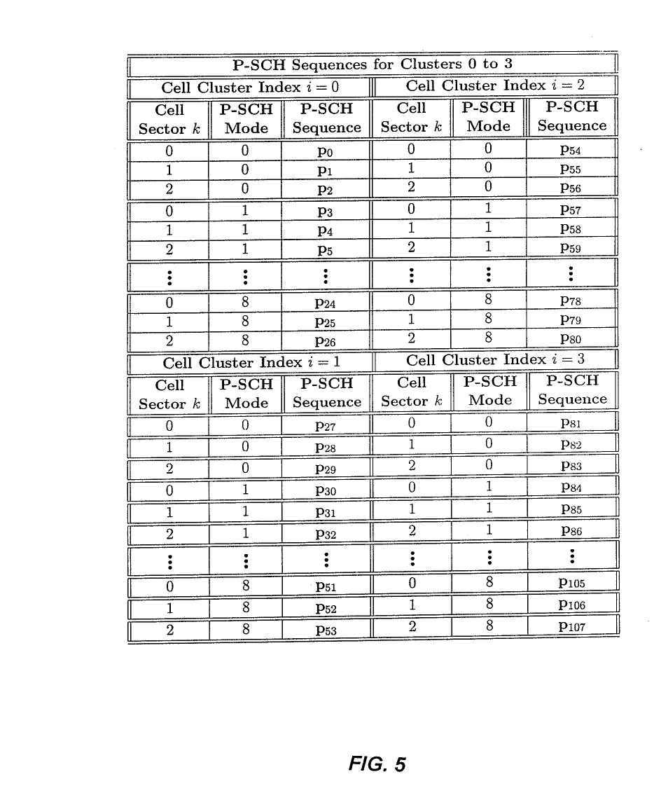

FIG. 5 is an exemplary table showing a map for encoding P-SCH modes, cell cluster indices i, and cell sector indices k. Orthogonal P-SCH sequences encode the cell type or relay station type, the system bandwidth used by the cell or relay station, and the cell sector in which the cell or relay station is located.

kron(pᵢ; [1 0]) denotes the Kronecker product of Pᵢ in row-vector form and the two element row vector [1 0]. Zero-valued row vectors g_{L} and g_{R} denote length-L_{LG} and length-L_{RG} guard bands. P_{Symbol} is constructed from the row vector concatenation of g_{L}, kron(pi; [1 0]), and g_{R}.

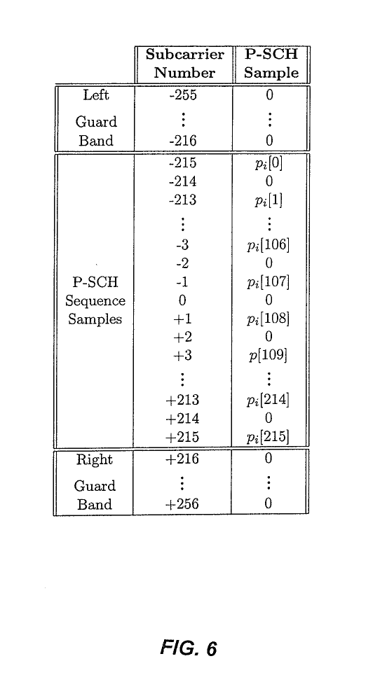

FIG. 6 is an exemplary table showing how samples of the P-SCH sequence Pᵢ are mapped to the subcarriers of a downlink OFDMA symbol, according to one embodiment. According to the example of FIG. 6, every other subcarrier is used, and even-valued subcarriers including the DC subcarrier are not used. As a result, the time-domain version of the sequence Pᵢ is repeated once. The left and right guard band lengths are L_{RG}=L_{LG}=40, according to one example.

The mapping of Pi to a frequency domain P-SCH symbol P_{Symbol} is defined as:

P_{Symbol}=[g_{L}kron(pᵢ,[1 0])g_{R}] (8)

The S-SCH transmits a sequence from a S-SCH sequence codebook S. Each S-SCH sequence within S encodes a cell index j, according to one embodiment. Some exemplary characteristics of the S-SCH may be as follows:

Variable bandwidths of 5, 7, 8.75, 10 and 20 MHz;

Frequency reuse of 3;

S-SCH codebook S common to all cell clusters; and

Carries partial cell ID information (cell indices).

The S-SCH sequence codebook may be defined as the set of orthogonal sequences:

S={(s₀^{S0},s₀^{S1},s₀^{S2}),(s₀^{S0},s₀^{S1},s₀^{S2}), . . . , (s_{N}_{_{Cells-1}}^{S0},s_{N}_{_{Cells-1}}^{S1},s_{N}_{_{Cells-1}}^{S2})} (9)

The S-SCH codebook generator sequence may be defined as:

$$gs [ k ] = ej \frac{π}{{L}_{S}} k ( k - {L}_{S} ) \qquad ( 10 )$$

Sequences for Sector 0 may be defined as:

$$\begin{matrix}{s}_{0} {s}_{0}^{S 0} = {\{ gs [ {k mod L}_{S} ] \}}_{k = 0}^{{L}_{S} - 1} & ( 11 ) \\ {s}_{1}^{S 0} = {\{ gs [ ( k - 1 ) {mod L}_{S} ] \}}_{k = 0}^{{L}_{S} - 1} & ( 12 ) \\ ⋮ & ( 13 ) \\ {s}_{NCells - 1}^{S 0} {\{ gs [ ( k - [ \frac{{L}_{S}}{3} - 1 ] ) ] {mod L}_{S} \}}_{k = 0}^{{L}_{S} - 1} & ( 14 )\end{matrix}$$

Sequences for Sector 1 may be defined as:

$$\begin{matrix}{s}_{0}^{S 1} = {\{ g [ ( k - \frac{{L}_{S}}{3} ) ] mod {L}_{S} \}}_{k = 0}^{{L}_{S} - 1} & ( 15 ) \\ {s}_{1}^{S 1} = {\{ gs [ ( k - [ \frac{{L}_{S}}{3} + 1 ] ) {mod L}_{S} ] \}}_{k = 0}^{{L}_{S} - 1} & ( 16 ) \\ ⋮ & ( 17 ) \\ {s}_{NCells - 1}^{S 1} = {\{ gs [ ( k - [ \frac{2 {L}_{S}}{3} - 1 ] ) {mod L}_{S} ] \}}_{k = 0}^{{L}_{S} - 1} & ( 18 )\end{matrix}$$

Sequences for Sector 2 may be defined as:

$$\begin{matrix}{s}_{0}^{S 2} = {\{ gs [ ( k - [ \frac{2 {L}_{S}}{3} ] ) mod {L}_{S} ] \}}_{k = 0}^{{L}_{S} - 1} & ( 19 ) \\ {s}_{1}^{S 2} = {\{ gs [ ( k - [ \frac{2 {L}_{S}}{3} + 1 ] ) {mod L}_{S} ] \}}_{k = 0}^{{L}_{S} - 1} & ( 20 ) \\ ⋮ & ( 21 ) \\ {s}_{NCells - 1}^{S 2} = {\{ gs [ ( k - [ {L}_{S} - 1 ] ) {mod L}_{S} ] \}}_{k = 0}^{{L}_{S} - 1} & ( 22 )\end{matrix}$$

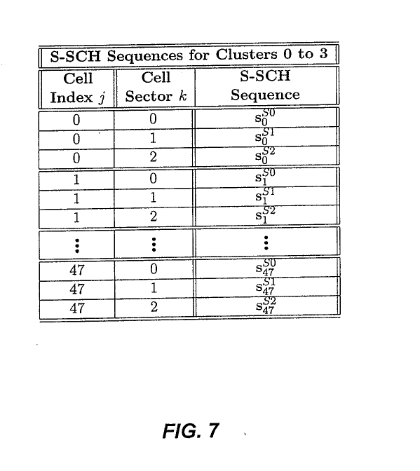

Sequences within S are of equal lengths, according to certain embodiments. The lengths may be defined, for example, as Ls=144, 288 and 576; N_{FFT}=512, 1024 and 2048. Each S-SCH sequence within S encodes a unique cell index j. Frequency-domain detection of a sequence in S produces a cell index j for a cell identifier Cell_IDp=f{i, j, k}. FIG. 7 shows an exemplary map for encoding cell indices j using sequences in S.

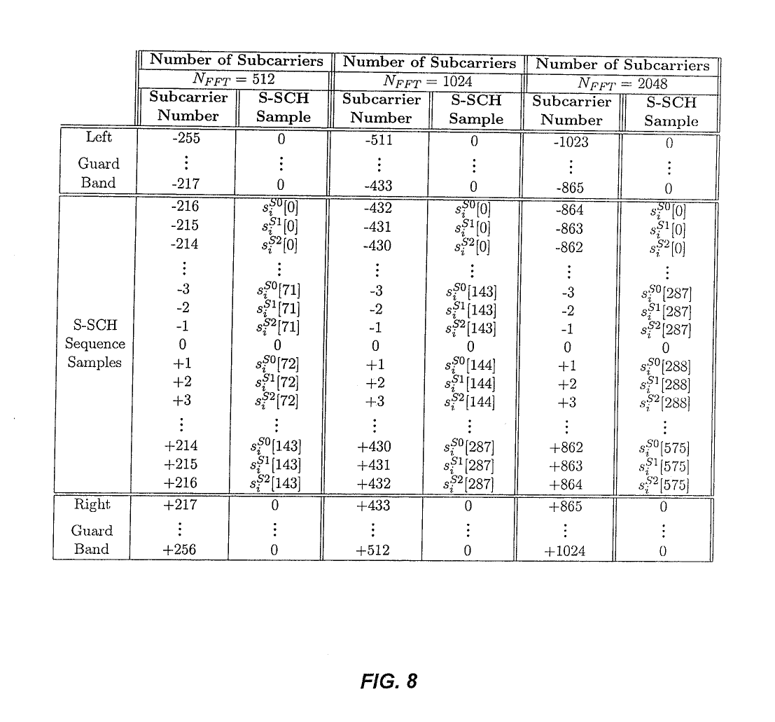

FIG. 8 shows an exemplary table indicating the mapping of samples of the S-SCH sector sequences to the subcarriers of a downlink OFDMA symbol, according to one embodiment. The sector sequences are interlaced within an OFDMA symbol, according to an embodiment. The left and right guard band lengths are L_{LG}=39, L_{RG}=40 for N_{FFT}=512, L_{LG}=79, L_{RG}=80 for N_{FFT}=1024, and L_{LG}=159, L_{RG}=160 for N_{FFT}=2048. The mapping of sector sequences sᵢ^{s0}, sᵢ^{s1}, and sᵢ^{s2} to a frequency domain S-SCH symbol S_{Symbol} is defined as:

S₀=kron(sᵢ^{s0},[1 0 0]) (23)

S₁=kron(sᵢ^{s1},[0 1 0]) (24)

S₂=kron(sᵢ^{s2},[0 0 1]) (25)

S=s₁+s₂+s₃ (26)

S_{Symbol}=[g_{L}sg_{R}] (27)

For s₀, kron(sᵢ^{s0}, [1 0 0]) denotes the Kronecker product of sᵢ^{S0} in row-vector form and the two-element row vector [1 0 0]. This may be similar for s₁ and s₂. Zero-valued row vectors g_{L} and g_{R} denote length-L_{LG} and length-L_{RG} guard bands. S_{Symbol} is constructed from the row vector concatenation of g_{L}, s, and g_{R}.

For exemplary purposed, and to further illustrate the methods and systems disclosed herein, certain properties of the SCH sequence codebooks may be described as follows:

Let Z denote the set of integers (positive, negative or zero) and Z_{Ls}={0, 1, . . . , Ls−1} be the additive group of integers Z modulo Ls. A Constant Amplitude Zero Autocorrelation (CAZAC) is a Ls-periodic sequence {s[k]}^{Ls-1}ₖ₌₀ sequence with the following properties:

Constant Amplitude (CA): For all k ε Z_{Ls} the sequence's magnitude is {s[k]}=1;

Zero Autocorrelation (ZAC): For all time delays m>=0 the magnitude of the sequence's periodic autocorrelation is:

$$\vert {ℛ }_{ss} [ m ] \vert = \vert {ℛ }_{ss} [ - m ] \vert \\ = \frac{1}{{L}_{S}} {\sum }_{k = 0}^{{L}_{S} - 1} s [ k ] s * [ ( k + m ) {mod L}_{S} ] \\ = \{ \begin{matrix}1 if m mod {L}_{S} = 0 \\ 0 otherwise\end{matrix} \qquad ( 28 )$$

CAZAC sequences are important SCH symbol candidates because of their defining properties: CA ensures optimal transmission efficiency. CA allows the transmission of peak power throughout the duration of an SCH symbol. This allows more power to be transmitted thereby increasing received SINR.

ZAC provides tight time localization. Sharp cross-correlation peaks obviate distortion and interference in the received waveform. If {s[k]}^{LS-1}ₖ₌₀ is a CAZAC sequence then it has the following properties:
Property 1: The complex-conjugated sequence {s*[k]}^{LS-1}ₖ₌₀ is also a CAZAC sequence.
Property 2: For any integer m the time-shifted sequence {s[k+m]}^{LS-1}ₖ₌₀ is also a CAZAC sequence.
Property 3: For any complex number K the sequence {Ks[k]}^{LS-1}ₖ₌₀ is also a CAZAC sequence.
Property 4: The discrete Fourier transform of {s[k]}^{LS-1}ₖ₌₀ is also a CAZAC sequence.
Property 5: A CAZAC sequence is a full bandwidth sequence with unity power spectrum.
Property 6: For any nth root of unity Wn and any integer m the cyclically shifted sequence {s[k]Wₙ^{m}}^{LS-1}ₖ₌₀ is also a CAZAC sequence.

There are different types of CAZAC sequences of any given length Ls. The different types may be useful for different applications. The different types result in different behavior with respect to Doppler and additive noise and interference. The different types of CAZAC sequences can be categorized into two distinct categories: quadratic-phase CAZAC sequences and quadratic-residue CAZAC sequences.

Quadratic-phase CAZAC sequences are linearly swept frequency sequences. Quadratic residue CAZACs are small alphabet CAZACs since elements can be of at most three distinct values. A quadratic-phase CAZAC sequence has elements in the form s[k]=e^{j((2nα)/Ls)*P(k)}, where P(k) is a quadratic polynomial. A length Ls quadratic-phase CAZAC sequence {s[k]}^{LS-1}ₖ₌₀ for k ε Z_{Ls} can be parameterized by writing its elements as:

$$s [ k ] = {e}^{j \frac{2 π a}{{L}_{s}} p ( k )} = \{ \begin{matrix}{e}^{j \frac{2 π a}{{L}_{S}} ( \frac{{k}^{2}}{2} + bk )} & if {L}_{S} is even \\ {e}^{j \frac{2 π a}{{L}_{S}} ( \frac{{k}^{2}}{2} + [ 2 b + 1 ] \frac{k}{2} )} & if {L}_{S} is odd\end{matrix} \qquad ( 29 )$$

Parameters α and b are integers in Z; α and Ls are relatively prime, meaning they have no common factor other than 1. Hence, sequence codebooks can be constructed by changing the values of parameters α and b. For example, setting b=−1, LS=64 and setting α equal to the seventeen values 3, 5, 7, 11, 13, 17, 19, 23, 29, 31, 37, 41, 43, 47, 53, 59 and 61 gives a sequence codebook of size seventeen. For example, α=1 and b=−i where i>=0 is an integer. Then s[k] can be written in the parameterized form:

$${s}_{i} [ k ] = \{ \begin{matrix}{e}^{j \frac{π }{{L}_{S}} k ( k - 2 i )} & if {L}_{S} is even \\ {e}^{j \frac{π}{{L}_{S}} k ( k - 2 i + 1 )} & if {L}_{S} is odd\end{matrix} \qquad ( 30 )$$

A cyclically shifted CAZAC sequence codebook as the set:

S={s₀,s₁, . . . , s_{L}_{ₛ}₋₁} (31)

where the ith sequence set is defined as a row of the unitary Ls-by-Ls matrix:

$$\begin{matrix}\begin{matrix}S = [ \begin{matrix}{s}_{0 } \\ {s}_{1} \\ {s}_{2} \\ ⋮ \\ {s}_{{L}_{S} - 2} \\ {s}_{{L}_{S} - 1}\end{matrix} ] \\ = [ \begin{matrix}{s}_{i} [ 0 ] & {s}_{i} [ 1 ] & … & {s}_{i} [ {L}_{S} - 2 ] & {s}_{i} [ {L}_{S} - 1 ] \\ {s}_{i} [ {L}_{S} - 1 ] & {s}_{i} [ 0 ] & … & {s}_{i} [ {L}_{S} - 3 ] & {s}_{i} [ {L}_{S} - 2 ] \\ {s}_{i} [ {L}_{S} - 2 ] & {s}_{i} [ {L}_{S} - 1 ] & … & {s}_{i} [ {L}_{S} - 4 ] & {s}_{i} [ {L}_{S} - 3 ] \\ ⋮ & ⋮ & & ⋮ & ⋮ \\ {s}_{i} [ 2 ] & {s}_{i} [ 3 ] & … & {s}_{i} [ 0 ] & {s}_{i} [ 1 ] \\ {s}_{i} [ 1 ] & {s}_{i} [ 2 ] & … & {s}_{i} [ {L}_{S} - 1 ] & {s}_{i} [ 0 ]\end{matrix} ]\end{matrix} & ( 32 ) \\ {s}_{i} [ k ] = \{ \begin{matrix}{e}^{j \frac{π }{{L}_{S}} k ( k - 2 i )} & if {L}_{S} is even \\ {e}^{j \frac{π}{{L}_{S}} k ( k - 2 i + 1 )} & if {L}_{S} is odd\end{matrix} & ( 33 )\end{matrix}$$

Matrix S is a right circulant matrix constructed from the generator or mother sequence s₀={s[k]}^{Ls-1}ₖ₌₀. The r_{shift}th row of S is defined as:

sᵣ_{_{shift}}={sᵢ[(k+r_{shift})mod L_{S}]}ₖ₌₀^{L}^{_{S}}⁻¹,r_{shift}=L_{S}−1,L_{S}−2, . . . , 0 (34)

A right circulant matrix is special type of Toeplitz matrix, where each row is a cyclic right shift of the row above. A right circular matrix is determined by its first row, hence:

S=circ(s₀)=circ(sᵢ[0],sᵢ[1], . . . , sᵢ[L_{S}−1]) (35)

where circ(s₀) denotes the right circulant matrix constructed from s0. Sequences within S are orthonormal, so:

$$\frac{1}{{L}_{S}} {s}_{i}^{H} {s}_{j} = \frac{1}{{L}_{S}} \vert = \frac{1}{{L}_{S}} {\sum }_{k = 0}^{{L}_{p} - 1} {s}_{i}^{*} [ k ] {s}_{j} [ k ] \vert = \{ \begin{matrix}1 & if i = j \\ 0 & otherwise\end{matrix} \qquad ( 36 )$$

To support a large number of identifiers the detection process requires a large number of cross correlations. However, for cyclically shifted sequences the detection process is simplified since only the generator sequence needs to be periodically cross correlated with a received sequence. When the generator sequence and a received sequence are cross correlated the magnitude of the periodic cross correlation will have a peak equal to the cyclic shift of the received sequence. The detected cyclic shift encodes the identifier.

According to an embodiment, it can be assumed that the length of the SCH is a power of two. At the receiver the sequence can be zero padded to a power of two if its length does not equal a power of two. The periodic cross correlation can then be computed more efficiently in the frequency domain using two FFT operations and one IFFT operation. In the time domain the number of complex multiplications required for the periodic cross correlation of Ls complex-valued length-Ls sequences is 2Lₛ². The main benefit of using FFT operations is to reduce the number of complex multiplications from approximately 2Lₛ² to approximately 2Ls(1+log₂(Ls)).

For a practical example, let Ls be 256, then the number of complex multiplications will be 4608 by applying the FFT. In contrast, the number of complex multiplications will be 2Lₛ²=131, 072 using a time domain correlation. Specifically, the periodic correlation lags [symbol] s₀s_{rshift}[m], m=0, 1, . . . Ls−1, can be computed efficiently as:

[symbol]

s₀sᵣ_{_{shift}}[0] [symbol] s₀sᵣ_{_{shift}}[1]| . . . | [symbol] s₀sᵣ_{_{shift}}[L_{S}−1]|┘=|ifft(conj(fft(s₀)offt(sr_{shift})| (37)

where, according to certain embodiments:
fft(s₀) denotes the FFT applied to s₀;
conj(fft(s₀)) denotes the complex conjugate of fft(s₀);
fft(s_{rshift}) denotes the FFT applied to a received version of s_{rshift}. The shift may be detected by the periodic cross correlation;
The operator o denotes the Hadamard product ((element-by-element product) of the two vectors conj(fft(s₀)) and fft(s_{rshift}); and
   |ifft(.)| denotes the magnitude of inverse FFT.

Note that the conj(fft(s₀) can be computed once and stored in memory. Hence one fft, one Hadamard product and one ifft operation may be required. The total number of complex multiplications is approximately 4Ls(1+log 2(Ls))+2Ls. For Ls=256 this number equals 9728 which is still significantly less when compared to the time domain approach which requires 2Ls²=131,072 complex multiplications.

Cells and sectors are logical network elements that can be assigned physical layer resources such as SCH sequences and frequencies. Similar to frequency reuse a sequence reuse scheme can also be implemented. Sequence reuse can decrease the number of required sequences and therefore decrease P-SCH synchronization time and S-SCH identifier detection time. For sequence reuse a cell cluster is a number of cells grouped together with each cell allocated a certain number of SCH sequences. The cluster is then repeated throughout a required network coverage area. Due to the geometry of the cell (modeled as hexagon for exemplary purposes), the number of cells per cluster can only have certain values. These values are determined by the equation:

N_{Cells}=i²=ij+j² (38)

where i and j denote integers. Each cluster is repeated by a linear shift i steps along one direction and j steps in the other direction. To find the nearest co-sequence cells using the shift parameters i and j the following steps may be followed:

Move i cells along any chain of hexagons; and

Turn 60 degrees clock wise or counter clock wise and move j cells.

The distance between the center of two co-sequence cells is the sequence reuse distance; it may be computed as Dᵢⱼ=R*sqrt(3Nᵢⱼ) where R denotes the cell radius. Dᵢⱼ is also the distance to the first tier of interfering co-sequence cells. In terms of the cluster size it can be shown an MS's signal-to-interference power ratio can be approximated by

$${( \frac{S}{1} )}_{dB} \approx 10 {log}_{10} [ \frac{{( 3 {N}_{Cells} )}^{γ / 2}}{{N}_{I}} ] + {δ}_{dB} \qquad ( 39 )$$

where δdB is a constant associated with antenna directivity and N_{I} the number of interferers. The antenna directivity term δ_{dB} is typically 3 to 5 decibels depending on antenna beamwidth. The term γ denotes the path loss exponent or slope. As γ increases the path loss slope increases and the interference decreases. Some exemplary values for γ may be γ=2 (free space), γ=2:5 (rural areas), γ=3 to 3:5 (suburban areas), γ=3:5 to 4 (urban environments), and γ=4 to 4:5 (dense urban environments). The cluster size is dictated by the first tier of interferers so N_{I}=6. However, with three 120 degree sectors per cell it can be shown that the interference is only from two cells instead of six so N_{I}=2. The resulting S/I increase is approximately 4.77 dB.

It can be assumed that cluster size is sufficient so the contribution of additional interferers for second and above tiers is marginal. Given an desired S/I target value and an exponent γ we can estimate an appropriate cluster size N_{Cells} by solving:

$$( \frac{S}{1} ) = {δ}_{dB} \approx 10 {log}_{10} [ \frac{{( 3 {N}_{Cells} )}^{γ / 2}}{{N}_{I}} ] \qquad ( 40 )$$

which gives

$${N}_{Cells} \geq ceil ( \frac{1}{3} {( N 1 \frac{S}{δdB1} )}^{2 γ} ) \qquad ( 41 )$$

According to the foregoing, various features of the disclosed methods and systems include SCH sequences serving as codewords that enable the unique identification of macrocells, femtocells, and relay stations. The length of the SCH sequences can match the number of allocated subcarriers. Hence, their correlation and spectral properties are not diminished by padding or truncation.

The SCH design facilitates the addition of new cell identifiers, this may be required if the 802.16m system increases in size. For example, the SCH design can be scalable in order to support numerous femtocells and relay stations that may be overlaid onto macrocells.

The SCH sequences are orthogonal, according to certain embodiments. The SCH sequences have good correlation properties, and the SCH sequences can have low correlation side lobes and high correlation peaks. The SCH sequences have flat power spectrums, and the PAPR of SCH sequences can be small (e.g., approximately 2.5 dB). This helps minimize clipping due to transmitter nonlinearity allowing maximal possible transmit power and increased system range.

The P-SCH sequences are suitable for fast AGC adjustment. The SCH design supports different bandwidths, and The SCH design supports multi-carrier implementations. The SCH sequences are well-suited for receiver signal estimation tasks such as signal quality estimation, channel estimation, and location estimation for location-based services (LBS).

The SCH sequences may be generated and detected using low computational complexity implementations. The SCH sequence design minimizes the number of detection hypothesis tests for cell/sector

While various embodiments of the invention have been described above, it should be understood that they have been presented by way of example only, and not by way of limitation Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

In this document, the terms “computer program product”, “computer-readable medium”, and the like, may be used generally to refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), when executed, enable the computing system.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

Furthermore, although individually listed, a plurality of means, elements or method steps may be implemented by, for example, a single unit or processing logic element. Additionally, although individual features may be included in different claims, these may possibly be advantageously combined. The inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for synchronization and cell identification within a communication system, comprising:
obtaining a primary synchronization channel including one or more symbols from a primary synchronization lookup table;
obtaining a secondary synchronization channel including one or more symbols from a secondary synchronization lookup table; and
transmitting a reference signal via a synchronization channel, including the primary synchronization channel and the secondary synchronization channel, wherein
the primary synchronization channel includes one or more symbols encoded with synchronization data, and
the secondary synchronization channel includes one or more symbols encoded with cell identification data.

2. The method of claim 1, wherein the primary synchronization channel is used for time and frequency synchronization.

3. The method of claim 1, wherein the primary synchronization channel is used for at least one of mode identification, cell cluster identification and cell sector identification.

4. The method of claim 1, wherein at least one of the primary and secondary synchronization channel is sued for at least one of signal quality estimation, channel estimation and location estimation.

5. The method of claim 1, wherein a length of the synchronization channel matches the number of allocated subcarriers.

6. The method of claim 1, wherein synchronization channel sequences are orthogonal.

7. The method of claim 1, wherein the primary synchronization channel has a fixed bandwidth.

8. The method of claim 1, wherein the secondary synchronization channel has a variable bandwidth.

9. The method of claim 1, wherein the primary and secondary synchronization channel lookup tables are common to all cell clusters.

10. A system for synchronization and cell identification within a communication system, comprising:
a station, comprising:
a processing unit configured to obtain a primary synchronization channel including one or more symbols from a primary synchronization lookup table in a storage unit, and a secondary synchronization channel including one or more symbols from a secondary synchronization lookup table in the storage unit; and
a transceiver unit configured to transmit to another station a reference signal via a synchronization channel, including the primary synchronization channel and the secondary synchronization channel, wherein
the primary synchronization channel includes one or more symbols encoded with synchronization data, and
the secondary synchronization channel includes one or more symbols encoded with cell identification data.

11. The system of claim 10, wherein the primary synchronization channel is used for time and frequency synchronization.

12. The system of claim 10, wherein the primary synchronization channel is used for at least one of mode identification, cell cluster identification and cell sector identification.

13. The system of claim 10, wherein at least one of the primary and secondary synchronization channel is sued for at least one of signal quality estimation, channel estimation and location estimation.

14. The system of claim 10, wherein a length of the synchronization channel matches the number of allocated subcarriers.

15. The system of claim 10, wherein synchronization channel sequences are orthogonal.

16. The system of claim 10, wherein the primary synchronization channel has a fixed bandwidth.

17. The system of claim 10, wherein the secondary synchronization channel has a variable bandwidth.

18. The system of claim 10, wherein the primary and secondary synchronization channel lookup tables are common to all cell clusters.

19. The system of claim 10, wherein the station is a base station or a relay station.

20. The system of claim 10, wherein the other station is a mobile station.
